(19) United States
(12) Patent Application Publication
(10) Pub. No.: US 2003/0061568 A1
(43) Pub. Date: Mar. 27, 2003

(54) Method, computer system, communication network, computer program and data carrier for filtering data

(75) Inventor: Willem Pieter Dijkstra, Roden (NL)

Correspondence Address: Thomas E. Wettermann, McDonnell Boehnen Hulbert & Berghoff, 32nd Floor, 300 S. Wacker Drive, Chicago, IL, 60606, US

(73) Assignee: Koninklijke KPN N.V., Groningen (NL)

(21) Appl. No.: 10/243,033

(22) Filed: Sep. 13, 2002

(30) Foreign Application Priority Data
Sep. 21, 2001 (EP) 01203582.0

(51) Int. Cl. G06F 17/30

(52) U.S. Cl. 715/513

(57) ABSTRACT

A method and system for filtering data in a network is provided. Initially a content type of data is determined, and if the content type is one of a number of predetermined content types, then a series of checks may be made. For example, the content syntax of the data may be determined and the content semantics of the data may be determined. The content syntax may be checked against a predetermined set of syntax rules corresponding to the predetermined content type and the content semantics may be checked against a predetermined set of semantic rules corresponding to the predetermined content type. If the content syntax and the content semantics satisfy the predetermined rules, then the data may be further processed. If the content syntax and the content semantics do no satisfy the predetermined rules, then the data may be discarded.

### FIELD OF INVENTION

The present invention relates to a method for filtering data and, more particularly, to a computer system, a communication network, a computer program and a data carrier for filtering data.

### BACKGROUND

From the International Patent publication WO 00/77668, an Extensible Mark-up Language (XML) proxy server is known. The XML proxy server determines whether a received document is an unprocessed XML document. If the received document is an unprocessed XML document, the server system searches a local cache memory for a processed version of the document and transmits the processed document to a client. If the document is not found in the cache memory, the proxy server processes the XML document and transmits the processed document to the client.

However, a problem of the known system is that no security measures are taken. For example, an XML code may be included in the data, which will cause the computer system executing the code to function improperly which might eventually result in crashing of the computer system. This code may be inserted in the data by a hacker. Furthermore, for instance in e-commerce systems, an XML code may be included in the data with the intent to perform fraudulent transactions.

### SUMMARY

It is an object of the invention to overcome or at least reduce these problems. In a first aspect, a method is provided for filtering data comprising the step of determining a content type of data. This content type describes the type of content in a message. This type may indicate that the message is an XML-message, a hypertext markup language (HTML) message, a video message, etc. In a preferred embodiment, it is further verified if the content type is one of a number of predetermined content types, and if it is, the method further includes executing at least one of the following steps: determining a content syntax of the data; determining a content semantics of the data; checking the content syntax against a predetermined set of syntax rules corresponding to the predetermined content type; and checking the content syntax against a predetermined set of semantic rules corresponding to the predetermined content type. The method can further comprise the steps of, if the content syntax and the content semantics do satisfy the predetermined rules, processing the data further or else discarding the data. By determining the syntax and semantics, the meaning or intent of the message may be understood.

Because data that do not satisfy the semantics rules and/or the syntax rules are discarded, the risks of damages to the network or system in the network may be reduced. In general, data with syntax or semantics errors may cause systems executing commands in the data to function improperly, since these systems will only be able to perform commands in conformity with the syntax and semantics rules. Furthermore, the risk of hacking the system is reduced, especially if the system according to the invention is combined with a firewall and/or proxy server system because it is likely that data sent with malicious intentions contain code representing commands non-conformal to the rules for semantics and/or syntax.

In another aspect, a computer system is provided for filtering data. The system at least includes at least one network communication device connectable to a data communication network and able to receive data from the data communication network when connected thereto and at least one processor device communicatively connected to the network communication device. The at least one processor device can be arranged at least to determine a content type of data, and if the content type is one of a number of predetermined content types, the processor may execute at least one of the following steps: determine a content syntax of the data and a content semantics of the data, check the content syntax against a predetermined set of syntax rules corresponding to the predetermined content type and check the content syntax against a predetermined set of semantic rules corresponding to the predetermined content type. In a preferred embodiment it is further verified whether the content syntax and the content semantics do satisfy the predetermined rules. The system may further process the data, or else discard the data. The computer system can further include at least one memory device communicatively connected to the processor device and provided with data representing at least one syntax database at least including data representing the predetermined set of syntax rules and/or at least one semantic database at least including data representing the predetermined set of semantic rules. The databases might be separate databases as well as being sub-databases of a single integral database.

Such a computer system may have an increased security, since it may perform a method according to the invention.

Also, the invention provides a data communication network including at least one first communication device connected to at least one second communication device, wherein at least one of said communication devices is a computer system according to the invention.

Such a data communication network is more secure, since data may be filtered by a computer system according to the invention

The invention further provides a computer program for running on a computer system. The computer program at least includes software code portions for performing steps of a method according to the invention when run on a computer system. Still further, the invention includes a data carrier, stored with data loadable in a computer memory said data representing a computer program according to the invention.

It is to be noted that the data communication network might be a wired as well as a wireless network. The method and system according to an embodiment of the invention may, for example, be applied for filtering or controlling synchronization commands as used in SyncML, a protocol under development for universal synchronization of data between devices in a wireless network.

### BRIEF DESCRIPTION OF FIGURES

Further details, aspects and embodiments of the invention will be described with reference to the figures in the attached drawings, wherein:

FIG. 1 shows an example of an embodiment of a computer system connecting a communication network to communication devices outside the network.

FIGS. 2 and 3 show flowcharts of an example of a method according to the invention.

FIG. 4 schematically shows a message in XML.

FIG. 5 schematically shows a syntax database for use in a computer system according to an embodiment of the invention.

FIGS. 6 and 7 schematically show a semantic database for use in a computer system according to an embodiment of the invention.

FIG. 8 schematically shows an example of an embodiment of a computer system according to the invention connecting an e-commerce database server system to a web front-end system in an Internet network.

FIG. 9 schematically shows two networks connected to each other via computer systems according to the invention.

### DETAILED DESCRIPTION OF EXEMPLARY EMBODIMENTS

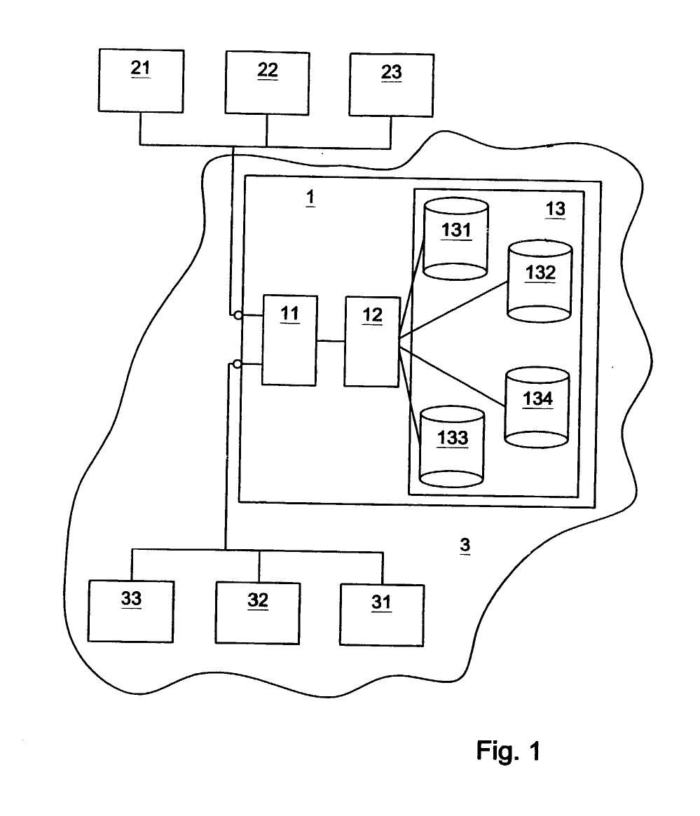

FIG. 1 shows a computer system 1 connecting a communication network 3 including communication devices 31-33 to communication devices 21-23 outside the network 3. The computer system 1 includes a network communication device 11, a processor device 12 and a memory device 13. The network communication device 11 is connected to the communication devices 21-23; 31-33 and may receive and send data from and to the network 3. The processor device 12 is connected between the network communication device 11 and the memory device 13. In this example, the memory device 13 includes a syntax database 131, a semantics database 132, a behavior database 133 and a content type database 134.

In operation, the computer system 1 receives data transmitted from the communication devices 21-23 to the communication devices 31-33 in the communication network 3. The data is received at the network communication device 11 and processed by the processor device 12. The network communication device may be of any suitable type. The network communication device may for example be a network card or a motherboard provided with an Ethernet adapter placed in a general-purpose computer or a router device, a switch device or any other device.

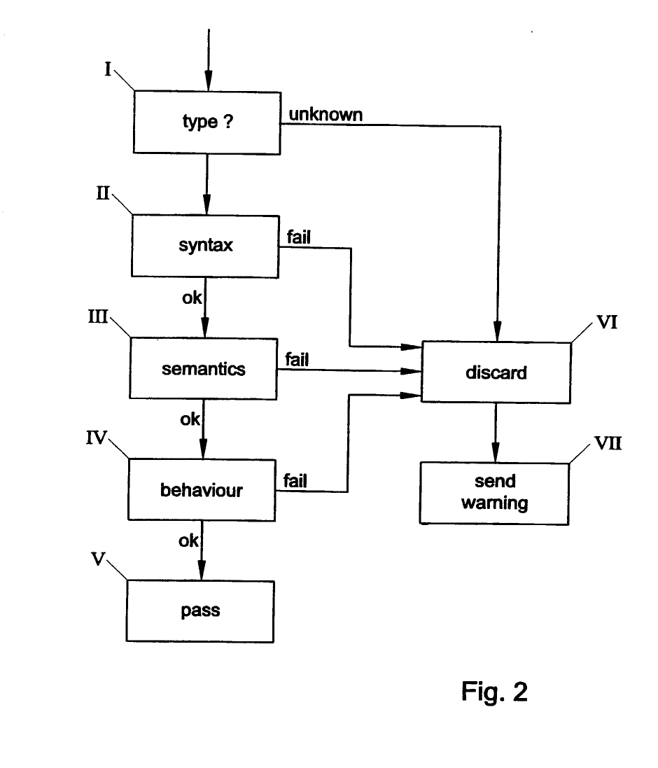

The processor device 12 is arranged for performing a method according to the invention, for example a method as represented by the flow-chart in FIG. 2 or a method as represented by the flowchart of FIG. 3.

In the method of FIG. 2, first a content type of data is determined in step I. If the content type is not recognized by the system, the data is discarded in step VI. In the system of FIG. 1, a list of content types is stored in the content type database 134. If the content type of the data corresponds to the content type in the database 134, in step 11 the syntax of the data content is determined and checked against a set of predetermined syntax rules corresponding to the content type of the data. The syntax rules in the system of FIG. 1 are stored in the syntax database 131. If the syntax is not correct, i.e. the syntax is not in conformity with the syntax rules, the data is discarded in step VI. If the syntax of the data is in conformity with the syntax rules the semantics of the data is determined and checked against a set of predetermined semantics rules in step III. If the semantics do correspond to the semantic rules, the data are processed further. If not, the data are discarded in step VI.

A computer system according to the invention is secure, because data that are likely to cause system failures are filtered out. In general, data with syntax or semantics errors are a likely cause of errors, since systems will only perform commands contained in the data which are in conformity with the syntax and semantics rules. Commands with syntactical and/or semantical errors may either be not recognized or cause unpredictable actions of the systems.

Furthermore, in a computer system according to the invention, the risk of hacking the system is reduced. It is likely that data sent with malicious intentions contain code representing commands are not-conformal to the rules for the syntax and/or semantics, since the intention of a hacker is to let the system function improperly or to perform illegal operations. Data that do satisfy the rules will not cause improper functioning. Therefore, filtering the data according to the invention increases the system security.

The processor device may further check the content of the data against a set of behavioral rules corresponding to the content type in step IV. The computer system 1 in FIG. 1 includes a behavioral database 133 comprising data representing the behavioral rules. When the data are in line with the rules, the data are processed further. If not, the data are discarded in step VI. The behavioral rules restrict the acceptance of content of the data, for example by describing ranges of values for variables or defining a number of times an action may be repeated by the systems in the network. The checking of the behavioral rules reduces the risk of damages to the network or system in the network further, since it is likely that data not corresponding to a normal behavior are sent with the intention to harm the system. Furthermore, the risk of fraud is reduced since unusual behavior is detected, such as excessive orders, for example ordering tens of thousands of a single item type.

If the data is discarded in step VI, a warning message may be sent to the intended receiver of the data in step VII. A warning message may likewise be sent to for example a system operator, a system administrator or a site security officer or another system or person interested in the security of the system. Also, the source of the message or data may be notified via a message that the data is discarded. Thereby, users are notified of possible fraud or hacking of the system and may take additional measures for protection of the network or tracking of the source of the fraud or hacking. Furthermore, the users may be asked to grant access to the data. This allows users to overrule the filtering, for example if the data are sent by a trusted third party and it is not likely that the data cause a system crash.

In the example of a method according to the invention represented by the flow-chart of FIG. 3 the steps II-IV of checking against a set of predetermined rules are performed substantially simultaneously. After the steps II-IV the results of the checking operation are compared in step VIII. The data are discarded in step VI if any of the checks fail. The comparing operation in step VIII may for example be an AND operation, resulting in a pass signal if the message satisfies all rules and a fail signal if the message does not satisfy at least one of the sets of rules. If the message has passed all checks, the data are passed through in step V and processed further.

The content type of the data may be determined with any method suitable for the specific implementation. For example, the processor may determine what type of mark-up language is used, such as standard generalized mark-up language (SGML), XML or HTML. As known to those skilled in the art, XML is defined as an application profile of the SGML that is defined by International Organization for Standardization (ISO) 8879. XML allows to design a specific mark-up language. In this regard, a predefined mark-up language, such as HTML, defines one manner in which to describe information in one specific class of documents. In contrast, XML allows to define customized mark-up languages for different classes of documents. As such, XML specifies neither semantics nor a tag set. However, XML provides a facility to define tags and the structural relationships between them. Reference is made to the Extensible Mark-up language recommendation published by the World Wide Web consortium, which is herein incorporated by reference.

In XML, the content type may for example be determined from the first lines of a message. In general, XML messages start with the following two tags in ASCI characters:

<?xml version=“[value]”>

<doctype “[document type]” system=“[external file]”>

Therefore, the content type of data starting with a tag beginning with the string ‘<?xml’ may be determined to be XML. The value of the version field [value] indicates the specific XML version used which may for example be version 1.0. The tag starting with ‘<?xml’ may further include other codes indicating specific properties of the message, such as the character encoding used or included external messages. Thus reading the first line of the message may reveal the content type of the message, such as XML version 1.0.

The tag <doctype “[document type]”> indicates the type of document which gives a more specific indication of the content type. In XML, document types are defined by the user; the XML standard does not describe a set of available document types. As shown in FIG. 1, the content types known by the computer system 1 may be stored in a content type database 134 in the memory device 13. The content type database 134 may for example include files for each mark-up language recognized by the computer system. For example, in a XML sub-database of database 134, the different document types may be listed. These document types for example may include “order”, “confirmation”, “bill” etc, when the computer system 1 is used to connect computer systems in networks of companies which handle business transactions. Thus reading the second line of the message may reveal a more specific document type. The document type determined from the first two lines of a message in XML may for example be: an order in XML version 1.0, a confirmation in XML version 1.0 etc.

The document type may be determined in a similar manner for documents of other types, for example in a different mark-up language such as HTML. In general, documents in other mark-up languages, such as HTML documents and SGML documents, start with a line specifying the language type of the message. Likewise, messages containing scripting commands, such as JavaScript or Visual Basic contain a corresponding line with a scripting language specification.

The syntax of the data may be determined and checked in any suitable manner. For example, in XML a Document Type Definition (DTD) is used which specifies allowed elements and attributes. A message in XML either includes the DTD or specifies an external file in which the DTD is stored. The DTD thus specifies the predetermined syntax rules and a number of DTDs may be stored in the syntax database 131.

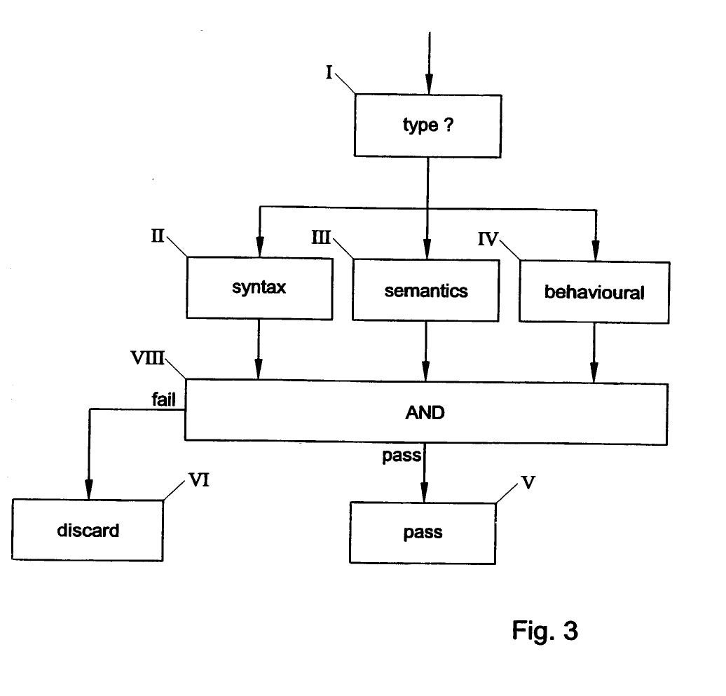

An example of a XML message is shown in FIG. 4. The message includes a number of elements 101-106. An element may include sub-elements and in its turn each sub element may include sub-sub-elements. The beginning of an element ‘elementname’ is indicated with the tag ‘<elementname>’ and the closing of an element is indicated with the tag ‘</elementname>’.

The example of FIG. 4 includes a type declaration element 101 which specifies the XML version used. The type declaration includes two tags 1011, 1012. The first tag 1011 defines the XML language used. The second tag 1012 defines the type of document, as is explained above. The declaration 101 is followed by an order element 102 which starts with tag 1021 and ends with tag 1022. The order element includes a customer element 103, which contains customer headers 1031, 1032, a name element 104, an address element 105, and a credit card element 106. The credit card element includes credit card element headers 1061, 1062, a type element 107 and a number element 108.

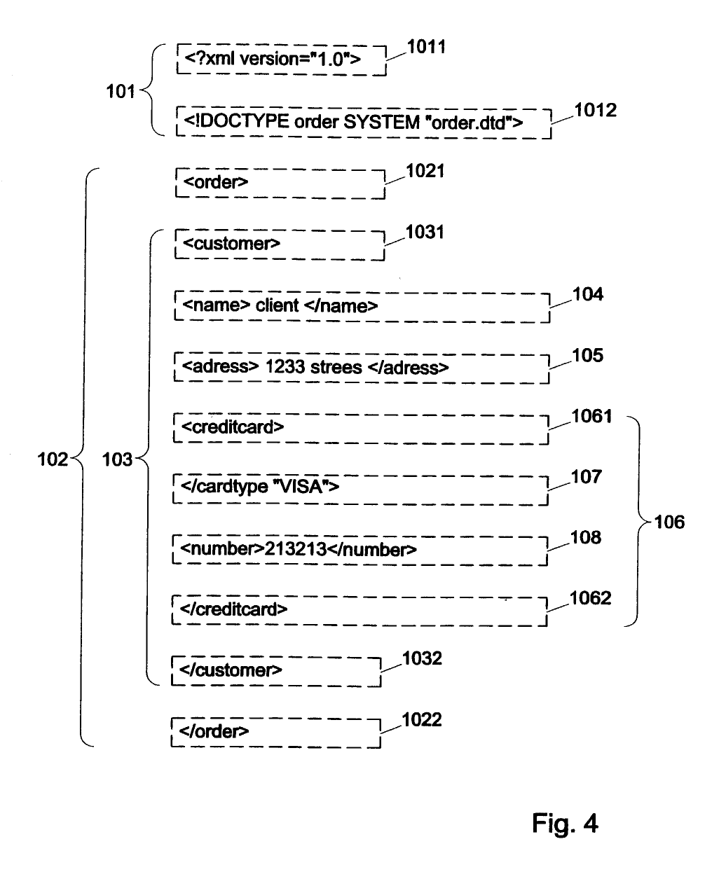

An example of a DTD 208 corresponding to the example shown in FIG. 4 is shown in FIG. 5. The DTD 208 defines element types 201-207 used in documents of type ‘order’. The DTD 208 includes headers 2081 and 2082. As indicated by tag 201, the element ‘order’ includes the sub-element ‘customer’. The element type customer includes the sub-elements name, address and credit card, as is indicated by tag 202. Tags 203-205 make a declaration of the element types name, address and credit card respectfully. The element credit card includes the sub-element types ‘cardtype’ and number which are declared by tags 206 and 207 respectfully. As is indicated with tag 2061 the elementtype cardtype may be of the type VISA, Amex or MasterCard. If the cardtype is used in a message, the type of card has to be includes as is indicated with the string ‘#required’ in tag 2061.

The DTD may be used to check the syntax of the message by comparing the declarations of elementtypes and attributes in the DTD with the elements and attributes thereof used in the message. When the elements and/or attributes do not check with the declarations in the DTD, the message is discarded and/or a warning is sent to an intended recipient of the data, a source of the data or a network administrator of the network the computer system 1 is part.

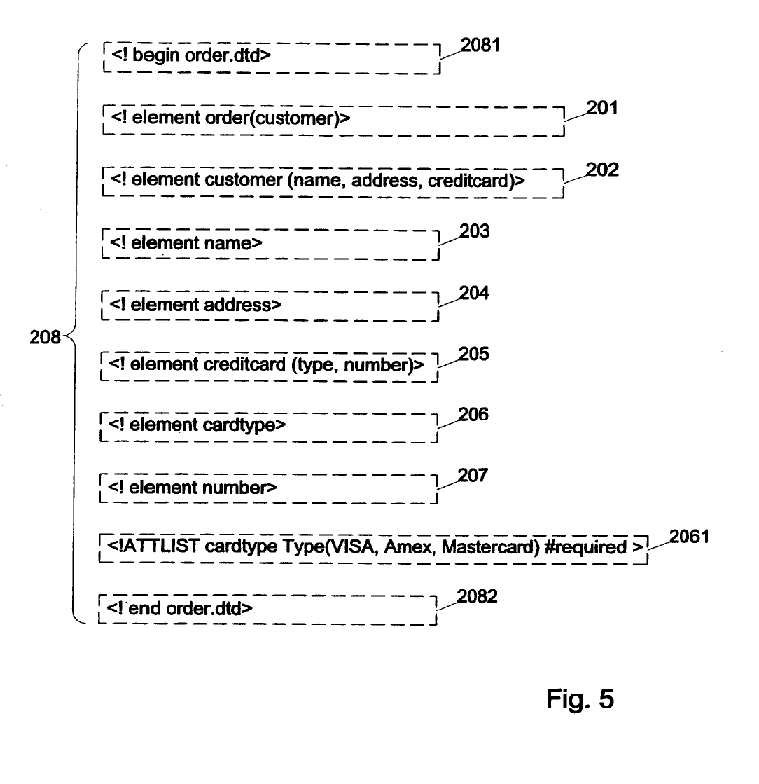

When the document type is XML, the semantics rules in semantic database 132 may at least include definitions of relations between elementtypes defined in the document type definition. For example the semantics rules may specify ranges of values of parameters and variables specified in the syntax rules. The semantics rules may specify relations between parameters and values. FIGS. 6 and 7 show examples of fields in the semantics database defining semantics rules. FIG. 6 shows a part of a semantics field 1321 of the elementtype ‘credit card’ stored in the semantics database 132. If the card type is Visa and the address of the cardholder is in the Netherlands, the card number should start with XX. Likewise if the card type is MasterCard and the address of the cardholder is in the Netherlands the card number should start with YY. Other examples are possible as well. FIG. 7 shows an example rule 1322 which defines a part of a flow of data. When the content type is ‘confirmation’, the previous data type should be ‘order’ and the next data type should be ‘bill’.

The behavioral rules may for example be determined from previous data for a source, like, for example in an e-commerce environment, previous orders for a specific source. The behavioral rules may for example be derived using data mining devices from one or more databases in which information relating to users of the system is stored. When data are received that differs significantly from the previous orders, it may be deemed to be not in line with the behavioral rules. For example, when a person has previously ordered less than ten compact disks per time, a message ordering a couple of hundreds of compact disks is probably fraudulent and may be discarded. Furthermore, odd transactions or parameter values may be defined in the behavioral database, such as a number of repetitions of a certain command or a relatively rare variable number, such as an number of books ordered which is above 100. Also, an average number of transactions per month for a specific user, an average amount of money spent per transaction or types of previously bought items may be used in the behavioral database.

The network communication device may be a single direction device, wherein data may only be received by the device and transmitted into the network 3. The network communication device may also be a (full) duplex device, that is a device able to receive and send data from and to the network when connected thereto.

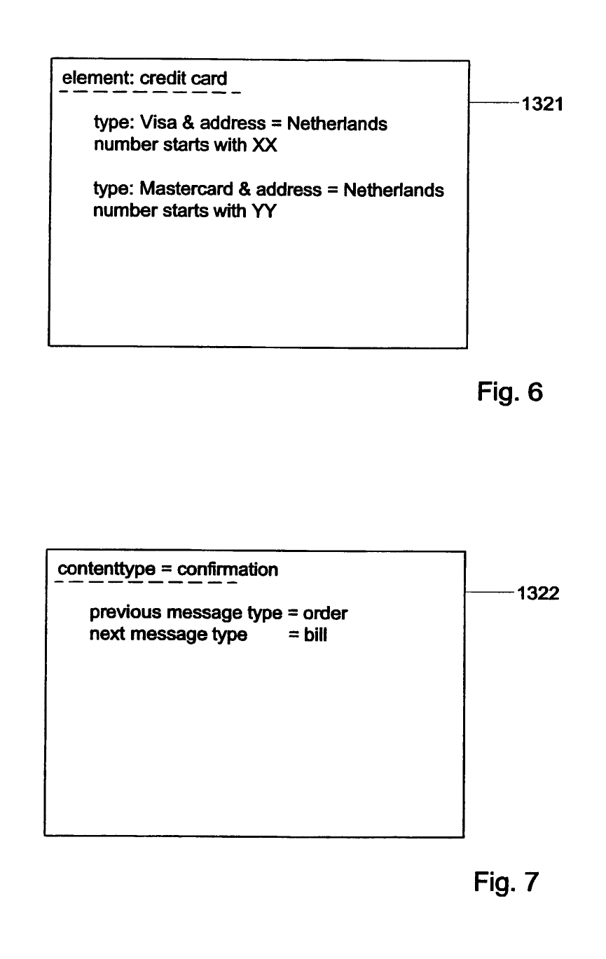

The computer system may be part of a data communication network including at least one first communication system connected to a second communication system. The computer system may likewise be a firewall server system in a data communication network. The data communication network may include at least one server system connected to a client system via the firewall server system. As shown in FIG. 8, the server system may be a web server front end system 21 connected to other systems 22-27 via the internet 2, for example the World Wide Web, while the client system is a database server system 3 including databases 31,32 which may handle transactions entered in the web server front end system 21 by the other systems 22-27.

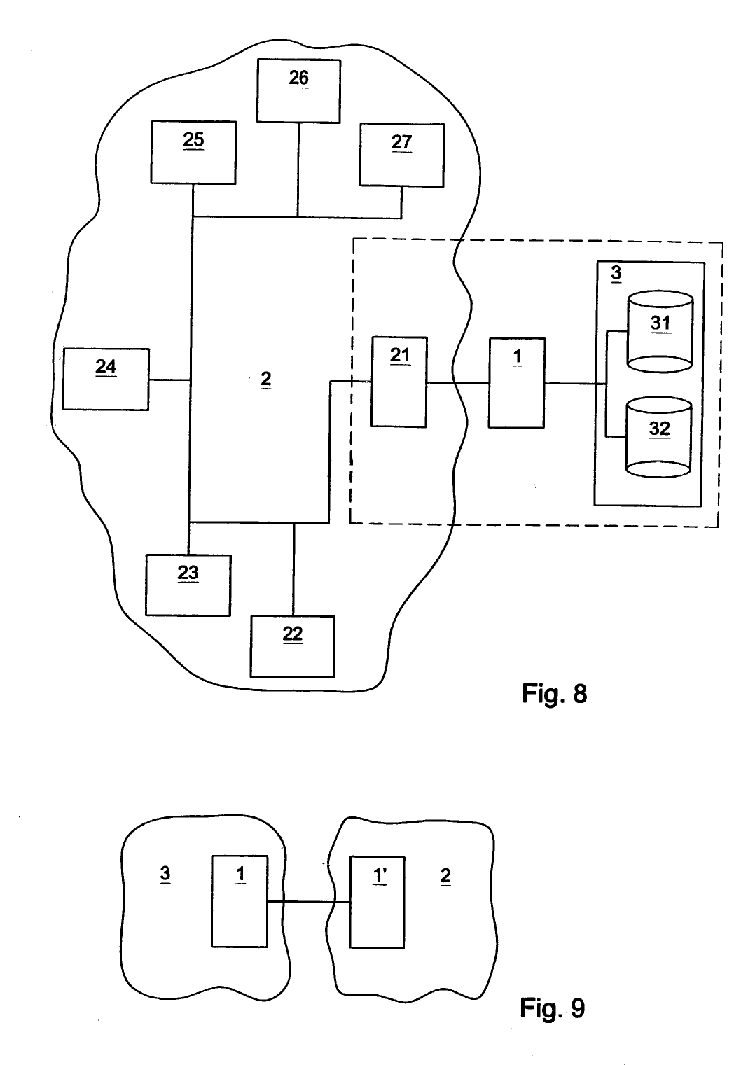

The computer system may also be a router device or a gateway device connecting at least two networks to each other. For example, as shown in FIG. 9 the computer system 1 may connect the network 3 of a first company to a network 2 of a second company via a second computer system 1′ according to the invention. The computer system 1 may also be a web server system and the second network an Internet network.

Furthermore, the invention may be applied to either data received by a network or data being transmitted from the network. For example in business-to-business connections outgoing data may be filtered with a method according to the invention or a system according to the invention, to provide a secure and stable connection.

The invention is not limited to implementation in the disclosed examples of physical devices, but can likewise be applied in another device. In particular, the invention is not limited to physical devices but can also be applied in logical devices of a more abstract kind or in software performing the device functions. Furthermore, the devices may be physically distributed over a number of apparatus, while logically regarded as a single device. Also, devices logically regarded as separate devices may be integrated in a single physical device. For example, in the processor device 12 in FIG. 1 memory devices may be implemented or in the memory device 13 some processing means may be integrated.

The invention may also be implemented in a computer program for running on a computer system. The computer program may at least include code portions for performing steps of a method according to the invention when run on a computer system or enabling a general propose computer system to perform functions of a computer system according to the invention. Such a computer program may be provided on a data carrier, such as a CD-ROM or diskette stored with data loadable in a memory of a computer system, the data representing the computer program. The data carrier may further be a data connection, such as a telephone cable or a wireless connection transmitting signals representing a computer program according to the invention.

While the invention has been described in conjunction with presently preferred embodiments of the invention, persons of skill in the art will appreciate that variations may be made without departure from the scope and spirit of the invention. This true scope and spirit is defined by the appended claims, which may be interpreted in light of the foregoing.

I claim:

1. A method for filtering data in a network, comprising the step of:
determining a content type of said data,
and if said content type is one of a number of predetermined content types executing at least one of the following steps:
determining a content syntax of said data and checking said content syntax against a predetermined set of syntax rules corresponding to said predetermined content type;
determining a content semantics of said data and checking said content semantics against a predetermined set of semantic rules corresponding to said predetermined content type;
and if said content syntax and said content semantics do satisfy said predetermined rules:
processing said data further, or else
discarding said data.

2. A computer readable medium having stored therein instructions for causing a central processing unit to execute the method of claim 1.

3 A method as claimed in claim 1, further including sending a warning message if said data is discarded.

4. A method as claimed in claim 1, further including determining a content of said data and checking said content against a set of predetermined behavioral rules corresponding to said content type.

5. A method as claimed in claim 4, wherein said predetermined behavioral rules are determined from previous data for at least one source of said network.

6. A method as claimed in claim 1, wherein said predetermined content types include an extensible mark-up language and said predetermined syntax rules include a document type definition which is at least partially in accordance with an extensible mark-up language protocol.

7. A method as claimed in claim 6, wherein said semantics rules at least include definitions of relations between element types defined in said document type definition.

8. A method as claimed in claim 7, wherein said semantics rules include a state transitions rule defining a flow of successive element types.

9. A computer system for filtering data including:
at least one network communication device connectable to a data communication network and able to receive data from said data communication network when connected thereto; and
at least one processor device communicatively connected to said network communication device, said at least one processor device at least being arranged to:
determine a content type of data,
and if said content type is one of a number of predetermined content types:
determine a content syntax of said data and check said content syntax against a predetermined set of syntax rules corresponding to said predetermined content type;
determine a content semantics of said data and check said content semantics against a predetermined set of semantic rules corresponding to said predetermined content type;
and if said content syntax and said content semantics do satisfy said predetermined rules:
process said data further, or else
discard said data.

10. A computer system as claimed in claim 9, wherein said computer system further comprises:
at least one memory device communicatively connected to said processor device and provided with data representing:
at least one syntax database at least including data representing said predetermined set of syntax rules; and
at least one semantic database at least including data representing said predetermined set of semantic rules.

11. A computer system as claimed in claim 10, wherein said predetermined content type at least includes an extensible mark-up language, and said syntax database is a document type definition database.

12. A computer system as claimed in claim 11, wherein said semantic database at least includes definitions of relations between element types defined in said document type definition.

13. A computer system as claimed in claim 12, wherein said semantics rules include a state transitions rule defining a flow of successive element types.

14. A computer system as claimed in claim 9, wherein said at least one processor device is further arranged to send a warning message to a system when said data is discarded.

15. A computer system as claimed in claim 10, wherein said at least one processor device is further arranged to determine a content of said data and to check said content with a predetermined set of behavioral rules corresponding to said content type and wherein said at least one memory device further includes at least one behavioral database at least including data representing said predetermined set of behavioral rules.

16. A computer system as claimed in claim 15, wherein said predetermined behavioral rules are determined from previous data for at least one source of said network.

17. A computer system as claimed in claim 9, wherein said at least one network communication device is further arranged to send said data to said at least one network when connected thereto.

18. A data communication network including:
at least one first communication device connected to at least one second communication device,
wherein at least one of the first and second communication devices is a computer system for filtering data and able to receive said data from said data communication network when connected, comprising at least one processor device, said at least one processor device at least being arranged to:
determine a content type of said data,
and if said content type is one of a number of predetermined content types:
determine a content syntax of said data and check said content syntax against a predetermined set of syntax rules corresponding to said predetermined content type;
determine a content semantics of said data and check said content semantics against a predetermined set of semantic rules corresponding to said predetermined content type;
and if said content syntax and said content semantics do satisfy said predetermined rules:
process said data further, or else
discard said data.

19. A data communication network as claimed in claim 18, wherein said computer system further comprises:
at least one memory device communicatively connected to said processor device and provided with data representing:
at least one syntax database at least including data representing said predetermined set of syntax rules; and
at least one semantic database at least including data representing said predetermined set of semantic rules.

20. A data communication network as claimed in claim 18, including at least one server system connected to a client system via at least one firewall server system, wherein at least one of said firewall server systems is a computer processing system comprising:
at least one memory device communicatively connected to said processor device and provided with data representing:
at least one syntax database at least including data representing said predetermined set of syntax rules; and
at least one semantic database at least including data representing said predetermined set of semantic rules.

21. A data communication network as claimed in claim 20, wherein said server system is a web server front end system and said client system is a database server system arranged to handle transactions entered in said web server front end system.

22. A data communication network as claimed in claim 20, wherein said server system is connected to at least one second network.

23. A data communication network as claimed in claim 22, wherein said server system is a web server system, and said at least one second network is an Internet network.

24. A data communication network as claimed in claim 22, wherein said at least one second network is a wireless network.

25. A data communication network as claimed in claim 24, wherein the computer processing system filters data received from said data communication network for SyncML synchronization commands.

26. A data communication network as claimed in claim 18, wherein said at least one first communication device and said at least one second communication device are arranged to send and receive extensible mark-up language data from and to each other.

27. A computer program for running on a computer system, at least including software code portions for performing filtering data in a network comprising the step of:
determining a content type of said data,
and if said content type is one of a number of predetermined content types executing at least one of the following steps:
determining a content syntax of said data and checking said content syntax against a predetermined set of syntax rules corresponding to said predetermined content type;
determining a content semantics of said data and checking said content semantics against a predetermined set of semantic rules corresponding to said predetermined content type;
and if said content syntax and said content semantics do satisfy said predetermined rules:
processing said data further, or else
discarding said data.

28. A data carrier, stored with data loadable in a computer memory, said data representing a computer program for running on a computer system, at least including software code portions for performing filtering data in a network comprising the step of:
determining a content type of said data,
and if said content type is one of a number of predetermined content types executing at least one of the following steps:
determining a content syntax of said data and checking said content syntax against a predetermined set of syntax rules corresponding to said predetermined content type;
determining a content semantics of said data and checking said content semantics against a predetermined set of semantic rules corresponding to said predetermined content type;
and if said content syntax and said content semantics do satisfy said predetermined rules:
processing said data further, or else
discarding said data.
